(19) United States
(12) Patent Application Publication
(10) Pub. No.: US 2005/0052949 A1
(43) Pub. Date: Mar. 10, 2005

(54) Use of pattern recognition in a measurement of formation transit time for seismic checkshots

(75) Inventors: Graham A. Gaston, Hannover (DE); Holger Mathiszik, Wathlingen (DE); Hans Rehbock, Wienhausen (DE)

Correspondence Address: MADAN, MOSSMAN & SRIRAM, P.C., 2603 AUGUSTA, SUITE 700, HOUSTON, TX, 77057, US

(73) Assignee: Baker Hughes Incorporated, Houston, TX (US)

(21) Appl. No.: 10/806,009

(22) Filed: Mar. 22, 2004

Related U.S. Application Data
(60) Provisional application No. 60/456,151, filed on Mar. 20, 2003.

(51) Int. Cl. G01V 1/24

(52) U.S. Cl. 367/57

(57) ABSTRACT

A method and system is provided for acquiring seismic data while conducting drill string operations in a wellbore. A seismic receiver is conveyed in a drill string to a location of interest; coded seismic signals are generated by a seismic source near a surface location; the coded seismic signals are detected with at least one sensor in the seismic receiver at least one location of interest in the wellbore as the drill string is operated in the wellbore; an arrival time of the detected seismic signal is computed in the seismic receiver; and the detected seismic signals or computed arrival times are stored in the seismic receiver or transferred to the surface.

### CROSS REFERENCES TO RELATED APPLICATIONS

This application claims priority from U.S. Provisional Patent Application No. 60/546,151 filed on Mar. 20, 2003.

### BACKGROUND OF THE INVENTION

1. Field of the Invention

The present invention is related to the field of geophysical exploration and more specifically to a method of using a seismic surface source to send signals to a drill string in a wellbore to acquire seismic data while drilling.

2. Description of the Related Art

In drilling a borehole to recover oil from the earth, it is often helpful to turn or steer the downhole drill bit toward or away from subterranean targets. To facilitate this geophysical steering, drillers need to know drill bit location on the seismic section. The location of targets ahead of the bit is also required, as well as some warning or indication of drilling hazards such as over-pressured formations or thin, shallow gas intervals. Surface seismic surveys generally include this information, but resolution and depth location is poor because surface seismic surveys are time based (rather than depth based) and the low frequencies generally available are not conducive for high resolution. For example, to determine the depth of a reflection, a speed of sound for the earth formation must be known. Consequently, these systems require depth calibration to accurately determine locations of target horizons or drilling hazards. Traditionally, this calibration has been provided by either offset well sonic data or wireline checkshot data in the current well. Offset data is often inadequate however due to horizontal variations in stratigraphy between wells.

During surface seismic surveys, a plurality of seismic sources and seismic receivers are placed on the surface of the earth. The seismic sources are triggered in a predetermined sequence, resulting in the generation of seismic waves. These seismic waves travel downward through the earth until reflected off some underground object or change in rock formation. The reflected seismic waves then travel upward and are detected at the seismic receivers on the surface. One or more clocks at the surface measure the time from generation of the seismic waves at each source to the reception of the seismic waves at each receiver. This gives an indication of the depth of the detected object underground. However, the exact speed of sound for these seismic waves is unknown, and thus, the exact depth of the detected object is also unknown. To more closely measure the exact speed of sound, a “wireline checkshot” acquired during drilling operations may be used to calibrate depth measurements by measuring the transit times between seismic sources and seismic receivers. During a “wireline checkshot,” a receiver on a “wireline” is lowered a known distance into an already-drilled borehole. A surface seismic source is then triggered and the time is measured for the seismic wave to travel to the wireline receiver. Because the depth of the wireline receiver is known, an average interval velocity indicating the average speed of the seismic wave can be determined with some degree of accuracy. Wireline checkshots, however, require interruption of the drilling operations by removing the drilling string out of the hole, commonly known as tripping, and so wireline checkshot surveys often prohibitively expensive.

Another seismic acquisition technique, Vertical Seismic Profiling (VSP), is conducted between seismic sources on or near the surface of the earth, and receivers in the earth, for example in a wellbore. Measurements are acquired of the response of a seismic sensor (like a geophone) at various depths in a borehole to sources on the surface. Sometimes the surface sources are moved about the area as well. Where the source is an appreciable distance from the well head, the result is termed an offset VSP; this provides a way to seismically “look” to the side of the borehole in the vicinity around the adjacent earth formation. For an “azimuthal VSP,” where the velocity field is sampled for azimuthal velocity changes relative to different lateral directions, sources are offset on the surface different directions from the borehole. In a walk-away VSP a surface source moves while the geophone in the borehole remains stationary; this provides another way to look to the side of the borehole. In a reverse VSP the source is in the borehole and geophones are on the surface. In a reverse VSP the noise generated by the drill bit during drilling operations may be used as a seismic source. VSPs are also acquired in directional and horizontal wells. A walk-above VSP is made with the sonde in a deviated hole and the source moved so as to be vertically above it.

There is a need to acquire seismic data, both checkshot transit time and VSP data during drilling operations without the expense of interrupting and halting the drilling operations. There is a need for a method and system of sending and receiving accurate high resolution checkshot and VSP seismic data in the vicinity of the drilling string generally and the drill bit particularly without the need to halt drilling operations.

The methods of the present invention overcome the foregoing disadvantages of the prior art by providing a technique for deploying a wellbore seismic receiver in a drill string without the use of a wireline and acquiring seismic data as the drill string operations are conducted within the wellbore.

### SUMMARY OF THE INVENTION

The present invention provides a method and system for acquiring seismic data while drill string operations are conducted in a wellbore. A method and system is described for acquiring seismic data while operating a drill string in a wellbore, comprising; conveying a seismic receiver proximate a lower end of the drill string or at other known locations in a drill string; generating coded seismic signals by a seismic source near a surface location; the coded signal may contain timing or instructional information; detecting the coded seismic signals with at least one sensor in the seismic receiver at at least one location of interest in the wellbore as drill string operations are conducted in a wellbore; computing the first arrival transit time or checkshot data in the seismic receiver; and storing the detected seismic signals in the seismic receiver. Additionally, the method comprises transmitting the computed arrival time to surface. The coded seismic signals may comprise timed discrete events or frequencies. A plurality of seismic receivers may be disposed along the drill string. The coded signal may be recorded at a near source sensor and stored to memory in a processing unit. Acquired data may be stored to memory in the seismic receiver and the data sent to the surface processor during drilling operations or subsequently after the drill string is removed from the wellbore. The checkshot data and VSP may be used to generate maps of subsurface features.

Further, a method and system is provided for acquiring seismic data while operating a drill string in a wellbore, comprising; synchronizing, at the surface, a surface clock in a surface controller with a downhole clock in a seismic receiver; programming, at the surface, a processor in the seismic receiver to activate during at least one predetermined time window after a predetermined delay time; conveying a seismic receiver in the drill string to a location proximate a lower end of the drill string or other known location in the drill string; generating, under control of a surface processor, coded signals by a seismic source near a surface location; detecting the generated seismic source signals with a near-source sensor and storing said signals in the surface processor; detecting the coded seismic signals with at least one sensor in the seismic receiver at at least one location of interest in the wellbore as the drill string conducts operations in the wellbore; computing a first arrival transit time in the seismic receiver; transmitting or otherwise transferring the first arrival transit time to the surface; storing the detected seismic signals in the seismic receiver; transferring, at the surface, the detected seismic signals from the seismic receiver to the surface processor; and processing the near-source signals and the seismic receiver detected signals according to programmed instructions to generate a seismic map.

Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of the preferred embodiment, taken in conjunction with the accompanying drawings, in which like elements have been given like numerals, wherein:

FIG. 1 is a schematic diagram of a seismic acquisition system for use in one embodiment of the present invention;

FIG. 2 is a block diagram of a seismic receiver for use in one embodiment of the present invention;

FIG. 3 is a schematic of a seismic acquisition system for use in one embodiment of the present invention;

FIG. 4 is a flow chart that illustrates the method and system of the present invention; and

FIG. 5 is a flow chart that illustrates the method and system provided by the present invention.

### DESCRIPTION OF PREFERRED EMBODIMENTS

Recognizing a single seismic event within a noisy environment, like that environment proximate to the well bore while drilling, is difficult by automatic means due to low signal to noise ratio. Surface emitted coded signals consisting of discrete timed events or frequencies are easier to recognize in the downhole conditions even given the losses and distortions due to the transit through the earth formations. Lower fundamental frequencies still retain the source generated recognizable pattern (whether the pattern is predetermined or not), allowing the downhole tool system to deduce the time of arrival of any given point on the pattern. This source generated pattern may be arbitrary or contain information about the time of source (“Source Time”) activation, thus enabling transit time calculation downhole as well as enabling determination of the absolute time of “first break arrival.” This “source time” may be used to synchronize the downhole and uphole (or near surface) clocks used in the acquisition system. The acquisition system thus has a self-check ability.

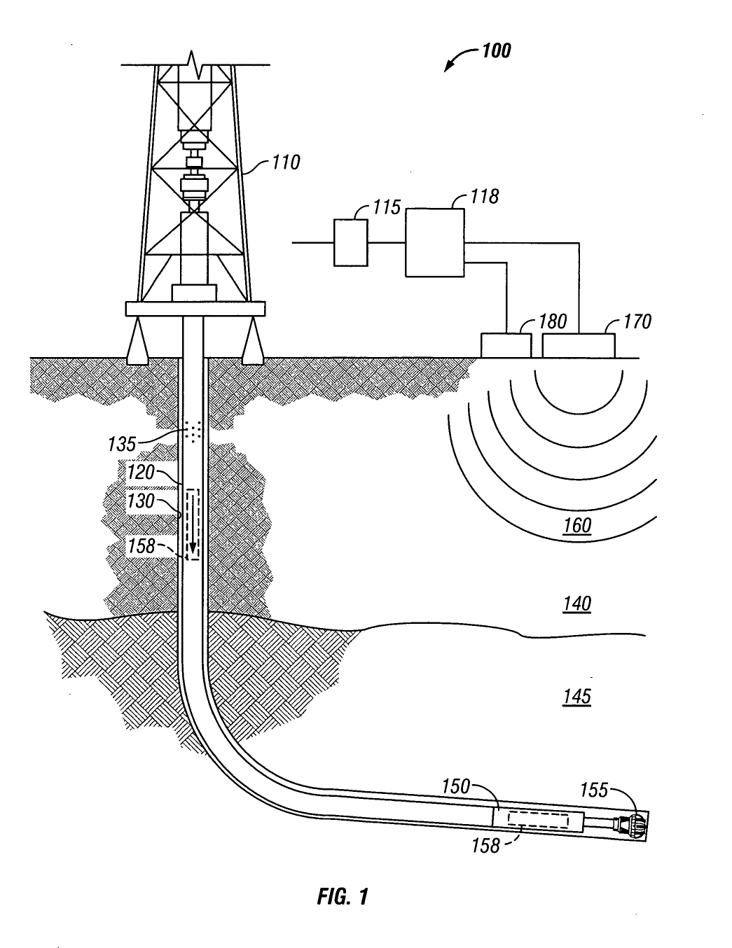

Referring to FIG. 1, a system 100 according to the present invention includes a derrick 110 with an attached drillstring 120. A drill bit 155 creates a well bore 130 through the surrounding formation 140, which may also include formation boundaries corresponding to, for example, an over-pressurized zone 145. A seismic receiver 158 with appropriate seismic sensors is inserted into the drillstring 120 and is located at a drill string receiver installation position 150, which installation position may be near the drill bit 155 or at other positions along the drill string. The seismic receiver 158 receives seismic signals 160 from a seismic source 170. The seismic source 170 may be an impulsive energy sequence generator or mechanical vibrator, located at the surface. The use of a particular source is exemplary only, as the system may be either land or marine-based, and is not seismic source-type specific. For example, an offshore system may include an air gun array or marine vibrator, either hung from an offshore platform or located near a service boat or anchored buoy.

The seismic source 170 contains the facility to generate and emit well-defined source patterns or specifically coded source signals. Examples of coded source signals suitable for emission from the surface to the downhole receiver during drilling operations include timed discrete event sequences and timed discrete event frequencies. Coded source signals are easier to recognize (i.e. to seismically separate the received signal from the drilling noise) in the downhole conditions while drilling even given the losses and distortions due to the transit through the earth formations and noise associated with drilling operations. Coded source signals provide suitable signals that may be processed in a downhole seismic receiver to provide seismic signal transit times (e.g., checkshot) from the surface source location to the downhole seismic receiver. Lower fundamental frequencies still retain the recognizable patterns (whether predetermined or not) allowing the downhole tool to deduce the time of arrival of any given point on the pattern. This pattern may be arbitrary or contain information about the time of source activation (“Source Time”), thus enabling transit time calculation downhole as well as absolute time of “first break arrival”. This “source time” may be used to synchronize the downhole and uphole clocks used in the measurement system. This allows the system a self-check ability. The seismic source 170 thus provides a suitable quality source signal that may be used both for vertical seismic profiling and for checkshot acquisition contemporaneous with active drilling operations.

Also located at the surface is a depth indicator 115 to measure the depth positions of the drill string (or drillstring) 120 and so to ascertain the depth of components on the drill string. A depth indicator may be placed in the BHA as well, and able to transmit depth information to the surface. The depth indicator signals are transmitted to a surface controller 118 where they may be time stamped and stored in memory. The surface controller 118 is connected to the seismic source 170 for controlling the generation of seismic signals. The actual connection between the controller 118 and the seismic source 170 can be hardwired, can be radio telemetry or any other suitable communication system. Surface controller 118 contains circuitry, processing capability, and memory storage, and functions according to programmed instructions to control the generation of coded or patterned seismic signals. The surface controller circuitry contains a real-time clock for time coding the transmitted source signal. A near-field sensor 180 of any appropriate type (for receiving electromagnetic, acoustic or mechanical signals) is located near the source 170 and is used to record the acoustic signature of the source 170; the same or an alternative sensor may be used as well to recieve any communication emitted from the downhole seismic receiver. The output of sensor 180 is transmitted to the surface controller 118 where it is time stamped and stored in memory. For example, the sensor 180 can receive and store the downhole-computed data or other information from downhole systems, for example the checkshot or source to seismic receiver transit time. The memory used for storing data in the surface processor or downhole seismic receiver may be internal random access memory, magnetic storage, optical storage, or any combination of these.

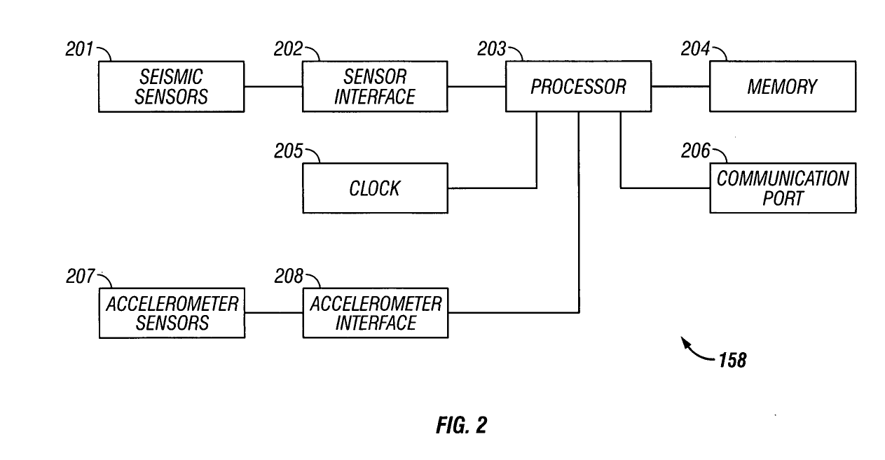

Referring to FIG. 2, the (downhole) seismic receiver 158 may comprise a combination of sensors 201 such as hydrophones and geophones along with suitable sensor interface circuitry 202, a processor 203, and memory 204 for storage of programmed instructions and storage of received seismic data. A real time clock circuit 205 is also included in the receiver 158 to provide time stamps for the received seismic signals. The surface located real-time clock and the seismic receiver located real-time clock 205 are synchronized at the surface before deploying the seismic receiver 158 into the wellbore 130 or into the drill string 120. A communications port 206 can be included to download program instructions to memory 204 and to upload stored seismic data to a surface system such as surface processor 118. The receiver 158 is powered by batteries (not shown) or other energy source (e.g., fuel cells, downhole generator, wireline, etc.). A similar seismic receiver that is deployable by slick-line is described in U.S. Pat. No. 5,555,220 to Minto, assigned to the assignee of this application and incorporated herein by reference. While receiver system 158 is illustrated in FIG. 1 at two positions within a drill string, the location and number of deployments are flexible.

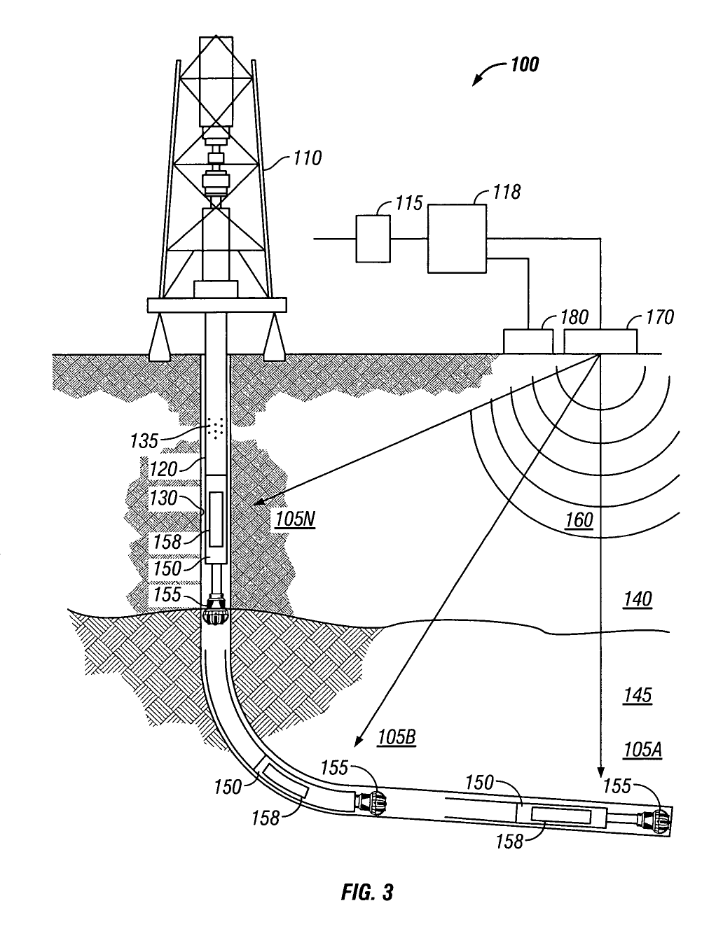

In operation, shown in FIG. 3, the seismic receiver has been deployed in the drill string 120 and may be located at position 105a. The seismic receiver 158 can be programmed at the surface to turn on the seismic receiving sensors 201 after a predetermined time delay. The time delay may be operator selected to allow the receiver 158 to reach a predetermined location before activating the seismic sensors 201. Alternatively, the time delays are selected for operational convenience. Or, communication protocols known in the art for use to communicate with downhole tools may be used to activate the seismic receiver according to specific instructions from the operator. After the programmed time delay, the surface processor 118 is initiated to begin to cycle the surface source 170 generating seismic signals 160 at predetermined intervals. The interval between signals can be selected, depending on receiver depth, in order to prevent overlap of successive signals.

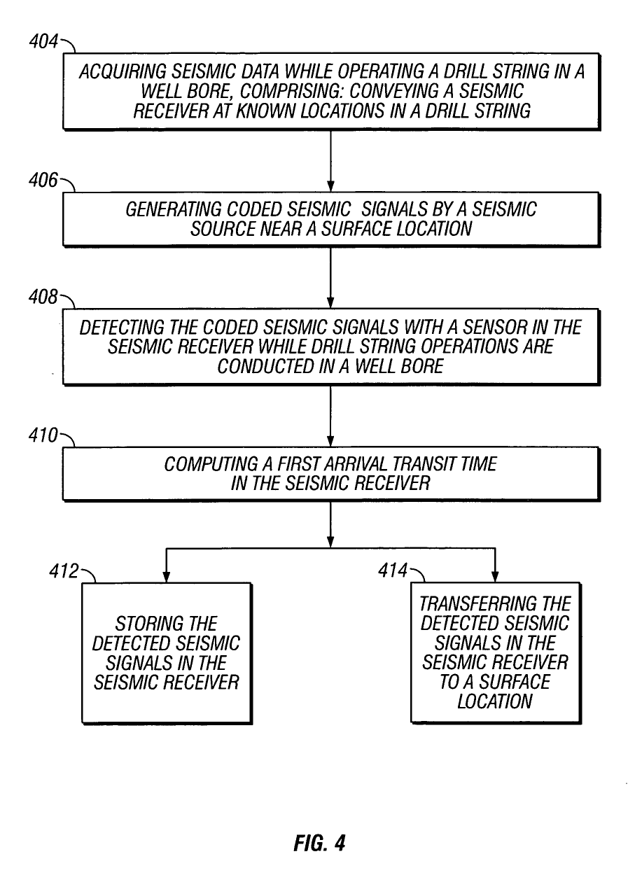

An embodiment of the method of the present invention provides for acquiring seismic data while conducting drilling operation in a wellbore is illustrated in FIG. 4: conveying at least one seismic receiver installed at a position in a drill string 404; generating coded signals by a seismic source near a surface location 406; detecting the seismic signals with at least one sensor in the at least one seismic receiver at least one location in the wellbore 408; and computing, in the seismic receiver 410, a transit time for the detected seismic signals. Optionally, the method comprises storing the computed time 412 in the receiver 158 or transmitting the computed arrival time to surface. The coded seismic signals may comprise timed discrete events or frequencies. A plurality of seismic receivers may be disposed along the drill string. The coded signal may be recorded at a near source sensor and stored to memory in a processing unit. Acquired data may be stored to memory in the seismic receiver and the data sent to the surface processor during drilling operations or subsequently after the drill string is removed from the wellbore. The checkshot data and VSP may be used to generate maps of subsurface features.

In another embodiment provided by the present invention, the receiver 158 of FIG. 2 is programmed to take samples during predetermined time windows selected by the operator. The receiver 158 may be incorporated into the drill string system as part of a non-rotating sleeve device. The surface processor is programmed to transmit coded seismic signals 406 as illustrated in FIG. 4 during these predetermined time windows. The predetermined time windows are selected to correlate with operational activities so that the sampling time windows will occur at desired sample locations or times in the wellbore. The operator can alter operations of the drill string during these windows to provide a relatively low noise environment for the seismic sensors 201. The receiver processor 203 samples, time stamps, and stores the detected signals during data acquisition in memory 204. Detected signals may be processed, formed into seismic records (410 of FIG. 4) such as checkshot transit times or VSP data, stored into memory, and/or compressed and transmitted back to the surface sensor 180 as illustrated in FIG. 4, 412, 414. Data acquisition may occur during normal drilling operations or the drill string may be stopped or otherwise operationally altered for data acquisition. The drill string may be stopped at predetermined locations in the wellbore 130 such as location 105b, 105n and the drill string 120 held stationary during the time sample windows predetermined for seismic acquisition. While three locations of interest are illustrated as examples in FIG. 3, any number of locations of interest may be chosen. The surface processor 118 cycles the source 170 activation during each sample window. The near-field sensor 180 detects each generated source signal and transmits the detected signal to the surface processor 118 where it is time stamped and stored in memory in the surface processor 118. At the end of the drilling process, the seismic receiver 158 is retrieved from the drill string receiver installation position 150. The time-stamped seismic signals are transmitted via the communications port 206 to the surface processor where they are processed with the near-field signals and the depth data, according to techniques known in the art, to provide data for an improved seismic map of the downhole formation.

In still another embodiment, the receiver 158 has at least one accelerometer 207 mounted in the receiver 158 to sense movement of the drill string 120, see FIG. 2. Signals from accelerometer 207 are conditioned by interface circuits 208 and fed to processor 203. Accelerometer 207 may be powered continuously from the time the seismic receiver 158 is inserted into the wellbore until the receiver is returned to the surface after the seismic data acquisition process. These accelerometer signals are used to switch the seismic receiving cycle on and off in receiver 158. When the drill string 120 is positioned at a location where it is desirable to take seismic data, such as 105a, 105b, and 105n in FIG. 3, the drill string 120 may be held stationary at the surface, or drilling operations may continue uninterrupted depending on operational considerations. The accelerometer generated signals are used by the processor 203 to determine drill-string position or that the drill-string 120 has stopped moving if prior to initiating the acquisition of seismic data. The processor is preprogrammed to receive and store data for a predetermined period of time sufficient to receive coded source signals. The source 170 is activated as described above and data is taken and stored from the near-field sensor 180 and the depth sensor 115 as described previously. As before, the downhole received and stored data is transferred to the surface processor 118 when the seismic receiver 158 is returned to the surface.

In yet another preferred embodiment, an acoustic source (not shown) is coupled to the drill-string 120 at the surface. The acoustic source transmits a coded signal through the drill-string 120 that is detected and decoded by the seismic receiver 158. The coded signal can be used to initiate the taking of data by the receiver 158. Such acoustic systems are known in the art and are not discussed here further.

Another embodiment of the method of the present invention provides for acquiring seismic data while drilling a well, comprising: conveying at least one seismic receiver system installed in a drill string; generating coded signals by a seismic source near a surface location; detecting the seismic signals with at least one sensor in the at least one seismic receiver at least one location in the wellbore; and storing the detected seismic signals in the seismic receiver.

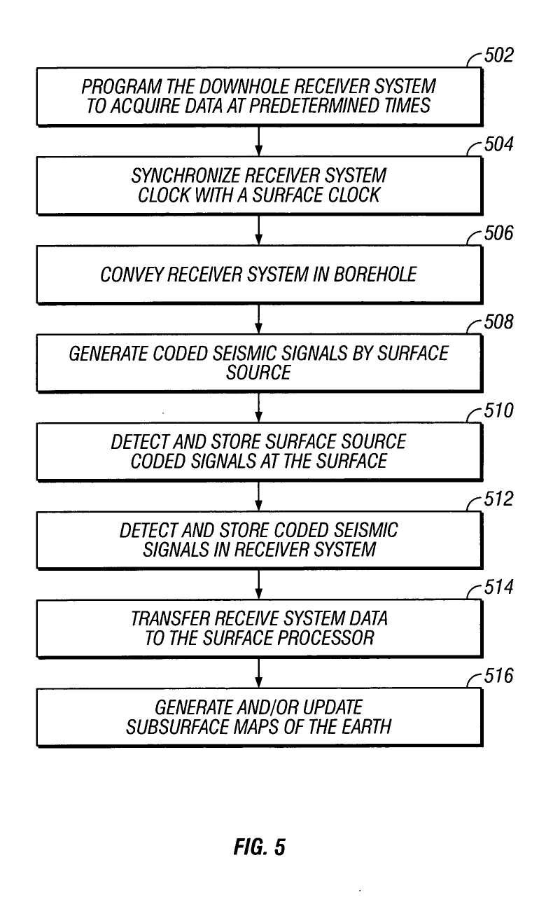

Therefore, a method of and system for acquiring seismic data during drill operations is illustrated in FIG. 5 and comprises: programming the seismic receiver system 158 of FIG. 2 at the surface 502 to enable acquisition during predetermined time intervals, to stay on and acquire data for a predetermined time, and/or to activate the acquisition process at predetermined times where the predetermined times correlate to locations of interest for taking seismic data; synchronizing a surface clock in the surface processor with a downhole clock in the seismic receiver 504; conveying the seismic receiver system 158 at locations along the drill string 506; generating coded seismic signals under control of the surface processor at the predetermined times correlating with the locations of interest of the seismic receiver as drilling operations are conducted in the wellbore 508; the coded signals may contain timing information and operational instructions; detecting the generated seismic signals by a near-source sensor and storing the detected signals and drill-string depth information in the surface processor 510; receiving and storing the generated seismic signals 512 from the surface with the seismic receiver system 158; the received signals may be correlated in real time in the downhole seismic receiver at the locations of interest as the receiver is conveyed along the wellbore and seismic data transit times through earth formations determined; transferring the seismic receiver data or determined transit times to the surface processor 514; the data may be transferred when the receiver system 158 is removed from the wellbore, or the system 158 may otherwise affect transmission to the surface, for example through port 206; and generating updated seismic maps of the formations surrounding the wellbore 516.

The foregoing description is directed to embodiments of the present invention for the purpose of illustration and explanation. It will be apparent, however, to one skilled in the art that many modifications and changes to the embodiment set forth above are possible without departing from the scope and the spirit of the invention. It is intended that the following claims be interpreted to embrace all such modifications and changes.

1. A method for acquiring seismic data while drilling a well, comprising;
(a) conveying at least one seismic receiver installed in a drill string;
(b) generating coded seismic signals by a seismic source at a surface location;
(c) detecting the coded seismic signals with at least one sensor in the at least one seismic receiver at least one location in the wellbore; and
(d) computing an arrival time for the detected seismic signals in the seismic receiver.

2. The method of claim 1 wherein said computed arrival time is transferred to the surface processor.

3. The method of claim 1 wherein said computed arrival time is stored in the seismic receiver.

4. The method of claim 1 wherein said coded seismic signals further comprise timed discrete events.

5. The method of claim 1 wherein said coded seismic signals further comprise timed discrete frequencies.

6. The method of claim 1 further comprising a plurality of seismic receivers located along the drill string.

7. The method of claim 1 further comprising;
i) detecting the seismic signal with at least one sensor located at the surface; and
ii) storing the signal detected by the at least one surface sensor in a surface processor.

8. The method of claim 1 further comprising transferring the signals stored in the seismic receiver to the surface processor upon removal of the drill string from the wellbore.

9. The method of claim 1 further comprising processing, according to programmed instructions, the surface detected signals and the seismic receiver detected signals to generate a seismic map.

10. A method for acquiring seismic data while drilling a well, comprising;
(a) conveying at least one seismic receiver installed in a drill string;
(b) generating coded seismic signals by a seismic source near a surface location;
(c) detecting the seismic signals with at least one sensor in the at least one seismic receiver at least one location in the wellbore;
(d) computing, in the seismic receiver, a checkshot transit time for the detected seismic signals; and
(e) transferring said checkshot transit time to the surface.

11. A method for acquiring seismic data while operating a drill string in wellbore, comprising;
(a) synchronizing, at the surface, a surface clock in a surface controller with a downhole clock in a seismic receiver;
(b) programming, at the surface, a processor in the seismic receiver to activate during at least one predetermined time window after a predetermined delay time,
(c) conveying the seismic receiver in the drill string to a location of interest in the wellbore;
(d) generating, under control of a surface processor, coded seismic signals by a seismic source near a surface location;
(e) detecting the generated seismic source signals with a near-source sensor and storing said signals in the surface processor;
(f) detecting the seismic signals with at least one sensor in the seismic receiver at a location of interest in the wellbore;
(g) storing the detected seismic signals in the seismic receiver;
(h) transferring the detected seismic signals from the seismic receiver to the surface processor; and
(i) processing the near-source signals and the seismic receiver detected signals according to programmed instructions to generate a seismic map.

12. A system for acquiring seismic data while drilling a well, comprising;
(a) a surface seismic source for generating coded seismic signals;
(b) a seismic receiver installed in a drill string to be conveyed in a bore hole, said seismic receiver comprising a sensor for detecting said coded seismic signals; and
(c) said seismic sensor enabled to compute an arrival time for a detected seismic signal.

13. The system of claim 12 wherein said seismic sensor is enabled to transfer the computed arrival time to the surface processor.

14. The system of claim 12 wherein said computed arrival time is stored in the seismic receiver.

15. The system of claim 12 wherein said coded seismic signals further comprise timed discrete events.

16. The system of claim 12 wherein said coded seismic signals further comprise timed discrete frequencies.

17. The system of claim 12 further comprising a plurality of seismic receivers located along the drill string.

18. The system of claim 12 further comprising at least one sensor located at the surface for detecting a coded seismic signal and a processor for storing the signal detected by the at least one surface sensor.

19. A system for acquiring seismic data while drilling a well, comprising;
(a) a surface seismic source for generating coded seismic signals;
(b) a seismic receiver installed in a drill string to be conveyed in a bore hole, said seismic receiver comprising a sensor for detecting said generated coded seismic signals; and;
(c) said seismic sensor enabled to compute a checkshot transit time for a detected seismic signal.
